(19) United States
(12) Patent Application Publication
(10) Pub. No.: US 2026/0017960 A1
(43) Pub. Date: Jan. 15, 2026

(54) CAPTIONING PIPELINES FOR ANNOTATING VIDEOS

(71) Applicant: Lemon Inc., Grand Cayman (KY)

(72) Inventors: Daquan Zhou, Los Angeles, CA (US); Zhijie Lin, Singapore (SG); Jiashi Feng, Singapore (SG)

(21) Appl. No.: 18/773,393

(22) Filed: Jul. 15, 2024

(51) Int. Cl. G06V 20/70; G06V 20/40

(52) U.S. Cl. CPC G06V 20/70; G06V 20/49

(57) ABSTRACT

Techniques and associated pipelines for generating captions and annotations of videos are provided. One aspect includes a method for captioning a video, the method comprising: receiving the video to be captioned; partitioning the video into a plurality of segments; for each of the segments, generating an image grid comprising a plurality of frames in the segment; for each of the image grids, generating an image grid caption describing the image grid using a generative multimodal model; and generating a consolidated caption for the video using the generative multimodal model or a generative language model to consolidate the image grid captions.

### BACKGROUND

Video generation is a high field of interest in the field of machine learning and artificial intelligence. Many different video generation methods have been contemplated, including the use of diffusion-based and language model-based models for video generation. The ability of these models to effectively generate high-quality videos generally relies on their training and datasets used for such training. Early training datasets for video generation models were created through manual annotation, which limited their scale. Subsequent methodologies aimed to increase dataset scale by utilizing automatic speech recognition (ASR) to extract text descriptions from videos. Although this approach significantly increased the amount of data, the ASR-generated text descriptions often fail to accurately represent the main video content. Another approach includes directly using readily available titles or descriptions of online videos as captions.

A common limitation of many existing training datasets for video generative models is that the vast majority of samples are short video clips, lacking coverage of long videos and especially dense descriptions of long-range dynamic scene changes. As such, training models to effectively generate long videos (e.g., longer than ten seconds) can be difficult due to the lack of high-quality training datasets. Some methodologies attempt to implement long video generation by training models on short video data and then employing sliding window generation techniques. However, these methods often suffer from quality degradation, lack of temporal consistency, and/or difficulty in generating high-quality long-range dynamic video content.

### SUMMARY

Techniques and associated pipelines for generating captions and annotations of videos are provided. One aspect includes a method for captioning a video, the method comprising: receiving the video to be captioned; partitioning the video into a plurality of segments; for each of the segments, generating an image grid comprising a plurality of frames in the segment; for each of the image grids, generating an image grid caption describing the image grid using a generative multimodal model; and generating a consolidated caption for the video using the generative multimodal model or a generative language model to consolidate the image grid captions.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows a schematic view of an example computing system for captioning and annotating videos.

FIG. 2 shows a data flow diagram of an example filtering process for large-scale video datasets, which can be implemented using the example computing device of FIG. 1.

FIG. 3 shows a data flow diagram of an example captioning process for annotating a video, which can be implemented using the example computing device of FIG. 1.

FIGS. 4A-4C show an example image grids with corresponding captions and a consolidated caption.

FIG. 5 shows a process flow diagram of an example method for captioning and annotating videos, which can be implemented using the example computing device of FIG. 1.

FIG. 6 shows a schematic view of an example computing environment in which the computer system of FIG. 1 may be enacted.

### DETAILED DESCRIPTION

Generating long videos with temporal consistency, rich contents, and large motion dynamics is desirable for various applications, such as AI-assisted film production. Although video generation models have achieved impressive results in generating short video clips (e.g., videos with durations under 10 seconds that are typically of 1-3 seconds in length), it remains challenging to simulate temporally consistent and dynamic content over long durations. Some methodologies attempt to extend video generation models trained on short video clips to long video generation by iteratively generating successive frames conditioned on previously generated frames. However, those methods suffer from temporal inconsistency and limited motion patterns.

The efficacy of video generation models can depend heavily on the quality of their training datasets. Previous video generation models are mostly trained using datasets of short video clips, which limits their ability to effectively generate long videos. One approach to this issue is to train video generation models directly on longer videos, enabling long-range temporal consistency and large motion dynamics in long video generation. However, high-quality long video datasets with dense annotations are rarely available and/or can be prohibitively expensive to curate. For example, previous training datasets of large-scale video-text pairs generally encounter limitations for training long video generators. Video datasets crawled from the Internet usually contain static videos or scene cuts, which are harmful to the training of video generation models. Moreover, previous training datasets for text-to-video generation are annotated with only short video captions, failing to capture the rich and dynamic semantics in long videos.

In view of the observations above, techniques and associated pipelines for generating annotating videos with captions are provided. Annotating and captioning videos can be performed in various ways. In some implementations, an automatic data curation pipeline is implemented for video filtering and long video captioning. The video filtering process can be implemented to select videos to be captioned from a large-scale video dataset based on various criteria. The criteria can be determined based on a set of metrics used to assess video quality for desired features, such as scene cuts, dynamic degrees, and semantic-level scores. For example, the video filtering process can be configured to select long videos covering at least ten seconds, long-take videos without scene cuts, and/or videos with large motion dynamics and diverse contents. Various techniques can be implemented to perform the filtering process, including but not limited to low-level filtering techniques (e.g., scene cut detection and optical flow estimation techniques) and semantic-level filtering techniques (e.g., generating semantic labels for videos using a generative multimodal model, and filtering the videos based on the semantic labels).

The video captioning process of the pipeline provides an approach to generate captions for long videos (e.g., the videos selected in the filtering process). In some implementations, the captioning process is implemented using a hierarchical captioning approach capable of generating temporally-dense captions for long videos. Compared to captions of previous video datasets, the hierarchical captioning approach described herein provides temporally-dense captions describing the transitions of actions and scenes over the whole duration of a video. The hierarchical approach includes splitting a long video into a plurality of segments. For each segment, a plurality of frames is sampled to be included in an image grid. The image grids (one for each segment) can be fed into a generative multimodal model that performs temporally-aware video captioning on the image grids to generate captions. The generative multimodal model is typically a pretrained transformer-based model configured to receive the image grids and generate text output for the captions. A separate generative language model or the generative multimodal model itself can then be used to refine and integrate the captions from the different segments into a consolidated caption describing the whole video.

The framework described herein provides several technical advantages. The filtering portion provides an automatic curation of high-quality videos, filtering out short, inconsistent, and small motion videos. The hierarchical captioning technique provides captions that are both temporally and spatially dense. The captioned videos can be utilized for various applications, including use as labeled data in a training dataset for video generation models. Pre-trained video generation models, including both diffusion-based and language model-based models, can be fine-tuned using such training datasets. As the captioned videos in the training dataset are curated based on predefined metrics, the model can be fine-tuned to perform better at generating videos with similar features (e.g., long videos with large motion dynamics).

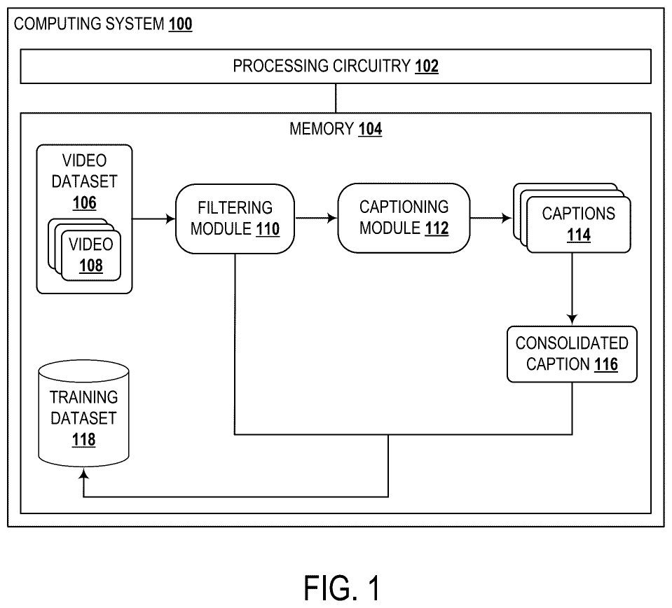

Turning now to the figures, captioning pipelines for annotating long videos with captions are described in further detail. FIG. 1 shows a schematic view of an example computing system 100 for captioning and annotating videos. The example computing system 100 can be implemented with various types of computing devices, including mobile devices, smart phones, personal computers, laptops, computing servers, etc. The example computing system 100 includes processing circuitry 102 and memory 104 storing instructions that, during execution, causes the processing circuitry 102 to perform the various processes described herein.

The example computing system 100 implements a data curation pipeline for filtering videos from large-scale video datasets and annotating the filtered videos with temporally- and/or spatially-dense captions. The pipeline starts with receiving a video dataset 106 comprising a plurality of videos 108. The video dataset 106 can be received in various ways and from various sources. The video dataset 106 can be a large-scale dataset with any number of videos (e.g., in the hundreds of millions). Oftentimes, the video dataset 106 indiscriminately includes videos from various data sources, and not all of such videos are suitable for long video generation. The captioning pipeline includes a filtering module 110 that applies one or more filtering criteria to select videos with desired features. For example, videos 108 in the video dataset 106 can include short videos (e.g., videos with durations of less than ten seconds), videos with scene cuts/changes, low motion videos, etc. These videos can be deemed low-quality for the purposes of training long video generation models. As such, the filtering module 110 can be applied to filter out such videos.

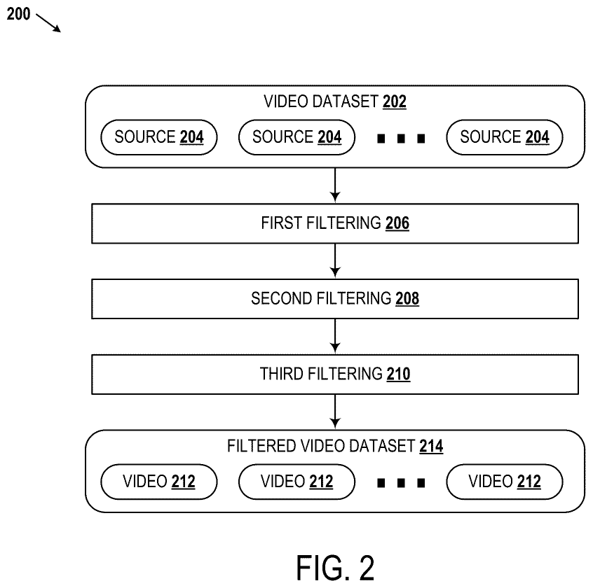

FIG. 2 shows a data flow diagram of an example filtering process 200 for large-scale video datasets. The example filtering process 200 employs multiple criteria to select videos with desired features from a video dataset 202. The video dataset 202 can be provided in various ways. In the depicted example process 200, the video dataset 202 is a large-scale video dataset that includes videos from various sources 204, such as stock footage providers, media platforms, etc. Depending on the sources 204, the video dataset 202 can vary widely in the number of videos that it contains. In some implementations, the video dataset 202 includes at least a hundred million videos.

The video dataset 202 can include videos with undesired features, such as features that can impede long video generation models from learning long-range temporal consistency and continuous motion across frames. Various filtering steps can be implemented to filter out undesired videos. In the depicted example process 200, multiple filtering steps are applied for multiple criteria. In other implementations, the filtering process includes a single filtering step. As can readily be appreciated, the number and type of filtering steps can depend on the criteria. Furthermore, the ordering of the filtering steps can also vary. For example, computationally intensive steps can be applied towards the end of the process as there will be fewer videos remaining to process.

The example filtering process 200 includes a first filtering step 206 to select videos with consistent scenes captured over ten seconds. For example, videos with scene cuts, fade-in/fade-outs, short videos (e.g., duration of less than ten seconds), etc. can be filtered out. The remaining long-take videos can be advantageous utilized in the training of video generation models to generate videos with long-range temporal consistency and continuous motion across frames. In some implementations, videos with smooth transition of scenes (e.g., the background of a street continuously changes as a person walks down the street) can be selected to remain while videos with scene cuts or slow shot changes with fade-in and fade-out effects caused by post-editing of videos are filtered out. Various techniques can be implemented perform the first filtering step 206. For example, tools for detecting sudden/slow shot changes and semantic consistency between early and late frames can be utilized to detect large scene changes.

The example filtering process 200 further includes a second filtering step 208 to select videos with large dynamic motion. Various techniques can be implemented to perform the second filtering step 208. In some implementations, optical flow techniques are applied to filter out static videos with little motion dynamics (e.g., videos with minimal motion, such as static scenes with still backgrounds). For example, the optical flow can be calculated between each pair of neighboring frames sampled at a predetermined number of frames per second, and videos containing an average optical flow magnitude below a predetermined threshold can be filtered out.

The example filtering process 200 further includes a third filtering step 210 to remove low-quality videos not detected by the previous filtering steps, such as videos that lack diversity and content variations, contain low perceptual qualities, contain extensive text overlays, etc. For example, an optical-flow-based criteria can filter out most near-static videos. However, some shaky videos captured by hand-holding cameras achieve high optical flow scores despite their lack of meaningful motion. The third filtering step 210 can be applied to filter out such videos. The third filtering step 210 can be performed in various ways. In some implementations, semantic-level filtering is performed using a multimodal model to remove said low-quality videos. The multimodal model can be configured to semantically label input videos with semantic labels that are indicative of a quality or characteristic of the videos. Further, videos with predetermined semantic labels indicative of undesirable contents (e.g., blur, glare, high-noise, high camera shake, etc.) can be filtered out. After the various filtering steps, the remaining videos 212 are selected to form a dataset 214 on which captioning is performed to generate a training dataset for the training of video generation models.

Referring back to FIG. 1, the captioning pipeline further includes a captioning module 112 that performs captioning on the filtered video dataset to generate a temporally-dense caption 114 for each video in the filtered dataset. The captioning module 112 can be configured to perform a hierarchical video captioning process for annotating long videos. In some implementations, the captioning module 112 generates a caption containing multiple sentences for a given video. The captioning process can be performed in various ways. In some implementations, the captioning module 112 includes a vision-language model capable of video understanding. The captioning module 112 can implement a vision-language model trained to generate detailed and temporally dense captions that capture the content of a given image. In some implementations, multiple frames are concatenated into a single image that is then captioned by the vision-language model. To capture content for a given video, multiple captions 114 can be generated for different portions of the video and combined to generate a consolidated caption 116 for the video.

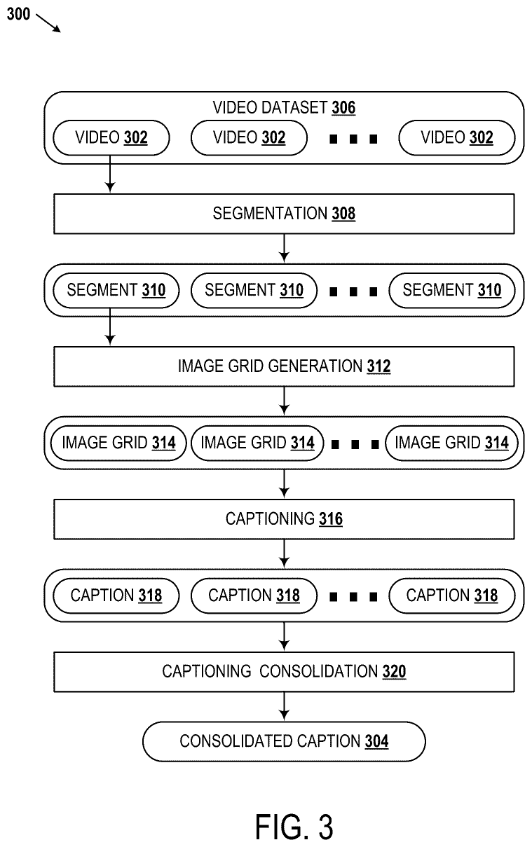

FIG. 3 shows a data flow diagram of an example captioning process 300 for annotating a video. The example captioning process 300 performs a hierarchical video captioning process capable of generating temporally-dense captions for long videos. The example captioning process 300 takes a video 302 as an input and generates a consolidated caption 304 describing the video 302. The video 302 can be provided in various ways. In the example captioning process 300, the video 302 is a video from a video dataset 306, such as the filtered dataset 214 of FIG. 2. The example captioning process 302 includes a segmenting step 308 that breaks the video 302 into a plurality of segments 310. The video 302 can be segmented in various ways. In some implementations, the video 302 is segmented into segments 310 of a predetermined duration. For example, the video 302 can be split into thirty-second clips (with a possible last remaining clip of less than thirty seconds). If the video 302 is shorter than the predetermined duration, the segmenting step 308 can be omitted. In some implementations, each segment 310 overlaps with its adjacent segments.

The example captioning process 300 further includes an image grid generation step 312 that generates a plurality of image grids 314 from the plurality of segments 310. For each segment 310, the image grid generation step 312 generates a different image grid 314. In the case where the segmenting step 308 was omitted, the image grid generation step 312 generates a single image grid 314 for the entire video. The image grids 314 can be generated in various ways. In some implementations, an image grid 314 includes a plurality of frames from a given segment 310. An image grid 314 can be implemented as a single composite image that includes the plurality of frames. In other implementations, the image grid 314 is implemented as a plurality of images, each image containing at least one of the plurality of frames. Any number of frames can be utilized. In some implementations, each image grid 314 includes a predetermined number of frames sampled from a respective segment 310. In further implementations, each image grid 314 includes six frames sampled from a respective segment 310. The frames can be sampled in various ways. For example, a predetermined number of frames can be sampled uniformly across a respective segment. In some implementations, the frames are randomly sampled from a respective segment.

The example captioning process 300 further includes a captioning step 316 that generates segment-level captions 318. The captioning step 316 can be performed to generate a caption 318 for each of the image grids 314. The captioning step 316 can be performed in various ways. In some implementations, the captioning step 316 utilizes a vision language model to provide details about the backgrounds, main characters, major actions, camera perspectives, etc. of a given image grid 314 (and the frames that it contains) to generate a corresponding segment-level caption 318. In some implementations, a generative multimodal model is utilized, which is configured to receive video frames in the form of the image grid 314 as input and to output caption 318 in natural language form describing the video frames in the image grid 314. As the image grid 314 can include multiple frames, the generated caption 318 can also provide temporal information, describing actions and changes throughout the frames. In some implementations, each of the captions 318 includes multiple sentences.

The example captioning process 300 further includes a caption consolidation step 320 that generates the consolidated caption 304 from the segment-level captions 318. During the captioning step 316, multiple segment-level captions 318 can be generated (e.g., one for every thirty-second segment of the video 302). However, as the scenes may not change from segment to segment (or from the end of one segment to the beginning of another segment), the segment-level captions 318 can include redundant information or, in some cases, extra interpretations or assumptions about the video 302. To provide more meaningful and compact information about the video 302, the caption consolidation step 320 can be performed to further refine the segment-level captions 318. The caption consolidation step 320 can be performed in various ways. In some implementations, the generative multimodal model discussed above can be further configured to receive segment-level captions 318 and generate a consolidated caption 320 therefrom. In other implementations, a separate generative language model is implemented to refine and merge the segment-level captions 318 to generate the consolidated caption 320, which provides temporally-dense information representing the whole video 302. For example, the generative multimodal model or the generative language model can be given a prompt to rewrite and compose the segment-level captions 318 into a consolidated caption 304 that describes the content and dynamics of the whole video 302.

Referring back to FIG. 1, the consolidated caption 116 can be utilized for various applications. In the depicted example computing system 100, the consolidated caption 116 generated from the image grid captions 114 (e.g., using the example captioning process 300 described in FIG. 3) can be paired with the video 108 on which the captioning process is performed. This forms a labeled data pair that can be included in a training dataset 118. Additional labeled data can be generated by repeating the process for the remaining videos 108 that persisted after the filtering process applied by the filtering module 110. The training dataset 118 can be utilized for various applications, including but not limited to the training of video generation models.

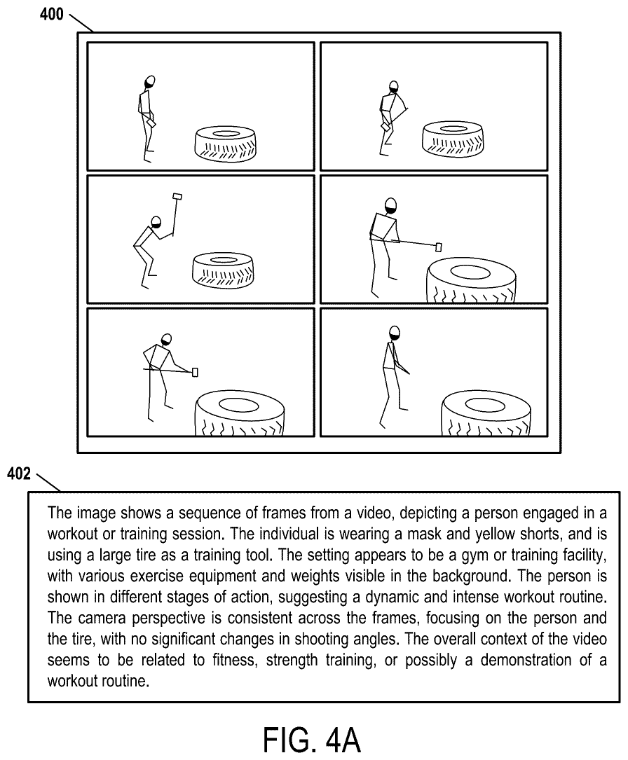

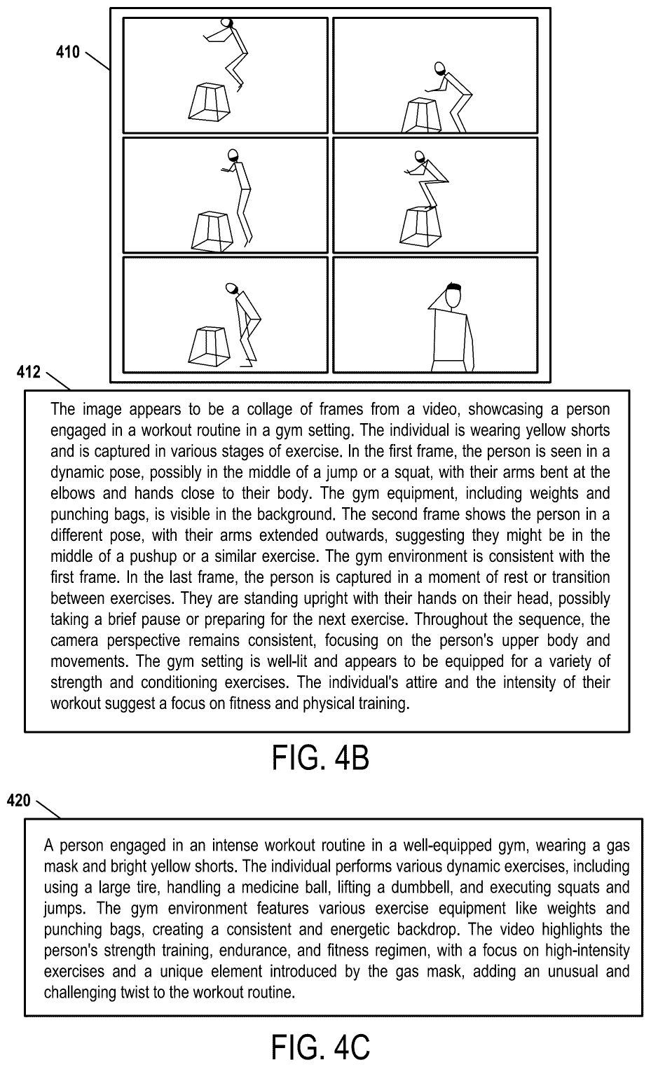

FIGS. 4A-4C show an example image grids with corresponding captions and a consolidated caption. FIG. 4A shows a first example of an image grid 400 and accompanying caption 402. The example image grid 400 and accompanying caption 402 can be generated, for example, through the hierarchical video captioning process as described and implemented using captioning module 112 of FIG. 1 and the example process 300 of FIG. 3. The example image grid 400 is a single composite image that includes six frames. The accompanying caption 402 describes the example image grid 400 with detailed and temporally dense information, describing how the sequence of frames depicts a person engaged in a dynamic and intense workout routine and different stages of action. FIG. 4B shows a second example image grid 410 and accompanying caption 412 derived from the same video as the examples shown in FIG. 4A. FIG. 4C shows a consolidated caption 420, which provides temporally dense description of the video by refining and merging at least the captions 402, 412 shown in FIGS. 4A and 4B.

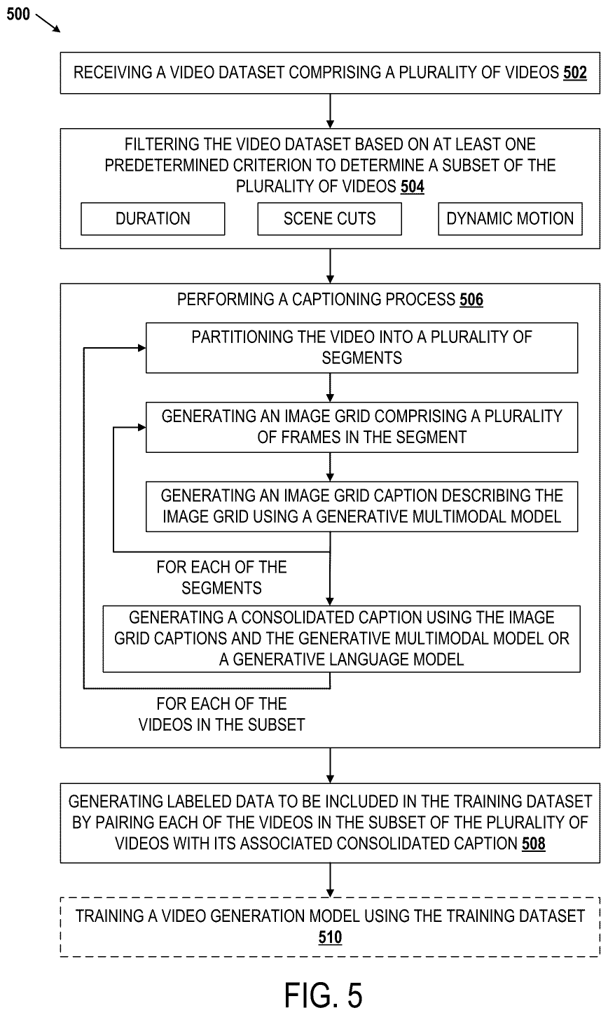

FIG. 5 shows a process flow diagram of an example method 500 for captioning and annotating videos. The example method 500 includes, at step 502, receiving a video dataset comprising a plurality of videos. The video dataset can be received in various ways and from various sources, including media platforms, stock footage providers, etc. The video dataset can be a large-scale dataset with any number of videos, which can be in the hundreds of millions or more. The example method 500 includes, at step 504, filtering the video dataset based on at least one predetermined criterion to determine a subset of the plurality of videos. Examples of features include video duration, the presence/absence of scene cuts, and the amount of dynamic motion. In some implementations, the subset of the plurality of videos is curated to include long videos with durations above a predetermined length, long-take videos without cuts, and/or videos with large motion and diverse contents.

The example method 500 includes, at step 506, performing a captioning process. The captioning process can be performed for each video in the subset of the plurality of videos determined at step 504. In some implementations, the captioning process is performed on a video with a duration of at least sixty seconds. The captioning process can include, for each of the video in the subset, partitioning the video into a plurality of segments. The video can be partitioned in various ways. In some implementations, the video uniformly partitioned such that the segments have similar durations. In some implementations, the video is partitioned into segments with durations of at least thirty seconds.

For each of the segments, the captioning process can include generating an image grid. The image grid can be generated in various ways. In some implementations, the image grid comprises a plurality of frames from a respective segment. The image grid can be implemented as a single composite image containing the frames. The plurality of frames can be sampled from the respective segment in various ways. In some implementations, the frames are sampled uniformly from the respective segment. In other implementations, the frames are sampled randomly from the respective segment. The number of frames per image grid can also vary. In some implementations, each image grid has a predetermined number of frames. In further implementations, each image grid has six frames sampled from a respective segment. For example, generating an image grid can include uniformly sampling six frames from a thirty-second segment. For each of the image grids, an image grid caption can be generated. The image grid captions can be generated in various ways. In some implementations, a generative multimodal model is utilized. For example, a vision-language model can be implemented to generate the image grid captions. The captioning process can further include generating a consolidated caption for the video using the generative multimodal model or a generative language model to consolidate the image grid captions.

The example method 500 includes, at step 508, generating labeled data to be included in the training dataset by pairing each of the videos in the subset of the plurality of videos with its associated consolidated caption. The example method 500 optionally includes, at step 510, training a video generation model using the training dataset. Various types of video generation models can be trained using the training dataset. For example, both diffusion-based video generation models and language model-based video generation models can be trained using the training dataset. In some implementations, trained models are fine-tuned using the training dataset. Fine-tuning video generation models, such as diffusion-based video generation models and language model-based video generation models, using the training dataset can boost the models' abilities in generating long-take videos with large motion dynamics and smoother background transitions from fine-grained text prompts.

As described throughout herein, high-quality long video datasets can be advantageously utilized for training long video generation models. The present disclosure provides an automatic data curation pipeline to filter high-quality long-take videos from large-scale video datasets and to annotate temporally-dense captions for the filtered videos. The pipeline includes a novel hierarchical captioning methodology that results in dense, information-rich captions for a given video. The resulting annotated videos can be utilized in a training dataset that can enable video generation models to generate long-take videos with high motion dynamics and smooth scene transitions.

In some embodiments, the methods and processes described herein may be tied to a computing system of one or more computing devices. In particular, such methods and processes may be implemented as a computer-application program or service, an application-programming interface (API), a library, and/or other computer-program product.

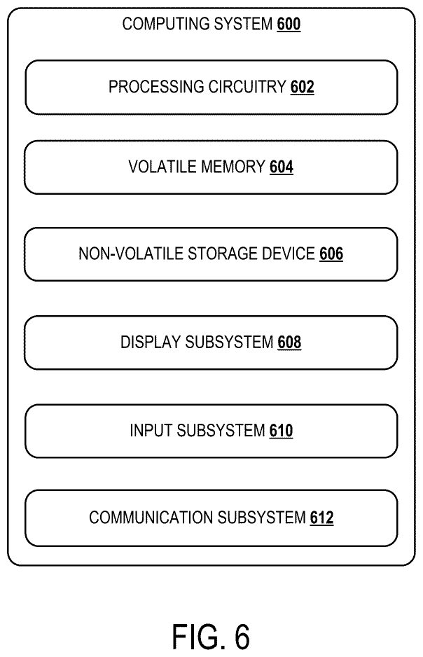

FIG. 6 schematically shows a non-limiting embodiment of a computing system 600 that can enact one or more of the methods and processes described above. Computing system 600 is shown in simplified form. Computing system 600 may embody the computing system 100 described above and illustrated in FIG. 1. Components of computing system 600 may be included in one or more personal computers, server computers, tablet computers, home-entertainment computers, network computing devices, video game devices, mobile computing devices, mobile communication devices (e.g., smart phone), and/or other computing devices, and wearable computing devices such as smart wristwatches and head mounted augmented reality devices.

Computing system 600 includes a logic processor 602 volatile memory 604, and a non-volatile storage device 606. Computing system 600 may optionally include a display subsystem 608, input subsystem 610, communication subsystem 612, and/or other components not shown in FIG. 6.

Logic processor 602 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 602 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 606 includes one or more physical devices configured to hold instructions executable by the logic processors to implement the methods and processes described herein. When such methods and processes are implemented, the state of non-volatile storage device 606 may be transformed—e.g., to hold different data.

Non-volatile storage device 606 may include physical devices that are removable and/or built in. Non-volatile storage device 606 may include optical memory, semiconductor memory, and/or magnetic memory, or other mass storage device technology. Non-volatile storage device 606 may include nonvolatile, dynamic, static, read/write, read-only, sequential-access, location-addressable, file-addressable, and/or content-addressable devices. It will be appreciated that non-volatile storage device 606 is configured to hold instructions even when power is cut to the non-volatile storage device 606.

Volatile memory 604 may include physical devices that include random access memory. Volatile memory 604 is typically utilized by logic processor 602 to temporarily store information during processing of software instructions. It will be appreciated that volatile memory 604 typically does not continue to store instructions when power is cut to the volatile memory 604.

Aspects of logic processor 602, volatile memory 604, and non-volatile storage device 606 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 600 typically implemented in software by a processor to perform a particular function using portions of volatile memory, which function involves transformative processing that specially configures the processor to perform the function. Thus, a module, program, or engine may be instantiated via logic processor 602 executing instructions held by non-volatile storage device 606, using portions of volatile memory 604. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 608 may be used to present a visual representation of data held by non-volatile storage device 606. The visual representation may take the form of a graphical user interface (GUI). As the herein described methods and processes change the data held by the non-volatile storage device, and thus transform the state of the non-volatile storage device, the state of display subsystem 608 may likewise be transformed to visually represent changes in the underlying data. Display subsystem 608 may include one or more display devices utilizing virtually any type of technology. Such display devices may be combined with logic processor 602, volatile memory 604, and/or non-volatile storage device 606 in a shared enclosure, or such display devices may be peripheral display devices.

When included, input subsystem 610 may comprise or interface with one or more user-input devices such as a keyboard, mouse, touch screen, camera, or microphone.

When included, communication subsystem 612 may be configured to communicatively couple various computing devices described herein with each other, and with other devices. Communication subsystem 612 may include wired and/or wireless communication devices compatible with one or more different communication protocols. As non-limiting examples, the communication subsystem may be configured for communication via a wired or wireless local- or wide-area network, broadband cellular network, etc. In some embodiments, the communication subsystem may allow computing system 600 to send and/or receive messages to and/or from other devices via a network such as the Internet.

The following paragraphs provide additional description of the subject matter of the present disclosure. One aspect provides a method for captioning a video, the method comprising: receiving the video to be captioned; partitioning the video into a plurality of segments; for each of the segments, generating an image grid comprising a plurality of frames in the segment; for each of the image grids, generating an image grid caption describing the image grid using a generative multimodal model; and generating a consolidated caption for the video using the generative multimodal model or a generative language model to consolidate the image grid captions. In this aspect, additionally or alternatively, the video has a duration of at least sixty seconds. In this aspect, additionally or alternatively, the video is uniformly partitioned. In this aspect, additionally or alternatively, each of the segments has a duration of at least thirty seconds. In this aspect, additionally or alternatively, generating the image grid comprises uniformly sampling the plurality of frames from the segment. In this aspect, additionally or alternatively, generating the image grid comprises sampling at least six frames from the segment. In this aspect, additionally or alternatively, each of the image grids comprises an image containing the plurality of frames. In this aspect, additionally or alternatively, generating the image grid caption comprises: inputting each of the plurality of frames of the image grid into the generative multimodal model to generate a plurality of frame captions; and combining the plurality of frame captions to generate the image grid caption. In this aspect, additionally or alternatively, the method further comprises generating a training dataset that includes a labeled data pair comprising the video and the consolidated caption. In this aspect, additionally or alternatively, the video does not include a scene cut.

Another aspect provides a computing system for captioning a video, the computing system comprising: processing circuitry and memory storing instructions that, when executed, cause the processing circuitry to: receive the video to be captioned; partition the video into a plurality of segments; for each of the segments, generate an image grid comprising a plurality of frames in the segment; for each of the image grids, generate an image grid caption describing the image grid using a generative multimodal model; and generate a consolidated caption for the video using the generative multimodal model or a generative language model to consolidate the image grid captions. In this aspect, additionally or alternatively, the video has a duration of at least sixty seconds. In this aspect, additionally or alternatively, the video is uniformly partitioned. In this aspect, additionally or alternatively, each of the segments has a duration of at least thirty seconds. In this aspect, additionally or alternatively, generating the image grid comprises uniformly sampling the plurality of frames from the segment. In this aspect, additionally or alternatively, generating the image grid comprises sampling at least six frames from the segment. In this aspect, additionally or alternatively, each of the image grids comprises an image containing the plurality of frames. In this aspect, additionally or alternatively, generating the image grid caption comprises: inputting each of the plurality of frames of the image grid into the multimodal model to generate a plurality of frame captions; and combining the plurality of frame captions to generate the image grid caption. In this aspect, additionally or alternatively, the instructions, when executed, further cause the processing circuitry to generate a training dataset that includes a labeled data pair comprising the video and the consolidated caption.

Another aspect provides a method for generating a training dataset for a video generation model, the method comprising: receiving a video dataset comprising a plurality of videos; filtering the video dataset based on at least one predetermined criterion to determine a subset of the plurality of videos; for each of the videos in the subset of the plurality of videos, performing a captioning process by: partitioning the video into a plurality of segments; for each of the segments, generating an image grid comprising a plurality of frames in the segment; for each of the image grids, generating an image grid caption describing the image grid using a generative multimodal model; and generating a consolidated caption for the video using the generative multimodal model or a generative language model to consolidate the image grid captions; and generating labeled data to be included in the training dataset by pairing each of the videos in the subset of the plurality of videos with its associated consolidated caption.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method for captioning a video, the method comprising:
receiving the video to be captioned;
partitioning the video into a plurality of segments;
for each of the segments, generating an image grid comprising a plurality of frames in the segment;
for each of the image grids, generating an image grid caption describing the image grid using a generative multimodal model; and
generating a consolidated caption for the video using the generative multimodal model or a generative language model to consolidate the image grid captions.

2. The method of claim 1, wherein the video has a duration of at least sixty seconds.

3. The method of claim 1, wherein the video is uniformly partitioned.

4. The method of claim 1, wherein each of the segments has a duration of at least thirty seconds.

5. The method of claim 1, wherein generating the image grid comprises uniformly sampling the plurality of frames from the segment.

6. The method of claim 1, wherein generating the image grid comprises sampling at least six frames from the segment.

7. The method of claim 1, wherein each of the image grids comprises an image containing the plurality of frames.

8. The method of claim 1, wherein generating the image grid caption comprises:
inputting each of the plurality of frames of the image grid into the generative multimodal model to generate a plurality of frame captions; and
combining the plurality of frame captions to generate the image grid caption.

9. The method of claim 1, further comprising generating a training dataset that includes a labeled data pair comprising the video and the consolidated caption.

10. The method of claim 1, wherein the video does not include a scene cut.

11. A computing system for captioning a video, the computing system comprising:
processing circuitry and memory storing instructions that, when executed, cause the processing circuitry to:
receive the video to be captioned;
partition the video into a plurality of segments;
for each of the segments, generate an image grid comprising a plurality of frames in the segment;
for each of the image grids, generate an image grid caption describing the image grid using a generative multimodal model; and
generate a consolidated caption for the video using the generative multimodal model or a generative language model to consolidate the image grid captions.

12. The computing system of claim 11, wherein the video has a duration of at least sixty seconds.

13. The computing system of claim 11, wherein the video is uniformly partitioned.

14. The computing system of claim 11, wherein each of the segments has a duration of at least thirty seconds.

15. The computing system of claim 11, wherein generating the image grid comprises uniformly sampling the plurality of frames from the segment.

16. The computing system of claim 11, wherein generating the image grid comprises sampling at least six frames from the segment.

17. The computing system of claim 11, wherein each of the image grids comprises an image containing the plurality of frames.

18. The computing system of claim 11, wherein generating the image grid caption comprises:
inputting each of the plurality of frames of the image grid into the multimodal model to generate a plurality of frame captions; and
combining the plurality of frame captions to generate the image grid caption.

19. The computing system of claim 11, wherein the instructions, when executed, further cause the processing circuitry to generate a training dataset that includes a labeled data pair comprising the video and the consolidated caption.

20. A method for generating a training dataset for a video generation model, the method comprising:
receiving a video dataset comprising a plurality of videos;
filtering the video dataset based on at least one predetermined criterion to determine a subset of the plurality of videos;
for each of the videos in the subset of the plurality of videos, performing a captioning process by:
partitioning the video into a plurality of segments;
for each of the segments, generating an image grid comprising a plurality of frames in the segment;
for each of the image grids, generating an image grid caption describing the image grid using a generative multimodal model; and
generating a consolidated caption for the video using the generative multimodal model or a generative language model to consolidate the image grid captions; and
generating labeled data to be included in the training dataset by pairing each of the videos in the subset of the plurality of videos with its associated consolidated caption.
